(19) United States
(12) Patent Application Publication
(10) Pub. No.: US 2024/0162457 A1
(43) Pub. Date: May 16, 2024

(54) FUEL CELL SYSTEM AND A FUEL CELL SYSTEM CONTROL METHOD

(71) Applicants: HYUNDAI MOTOR COMPANY, Seoul (KR); KIA CORPORATION, Seoul (KR)

(72) Inventor: Min Gu Park, Hwaseong-si (KR)

(73) Assignees: HYUNDAI MOTOR COMPANY, Seoul (KR); KIA CORPORATION, Seoul (KR)

(21) Appl. No.: 18/140,319

(22) Filed: Apr. 27, 2023

(30) Foreign Application Priority Data
Nov. 14, 2022 (KR) 10-2022-0151903

(51) Int. Cl. H01M 8/04089; H01M 8/04302; H01M 8/04701; H01M 8/04746; H01M 8/04992

(52) U.S. Cl. CPC H01M 8/04089; H01M 8/04302; H01M 8/04723; H01M 8/04731; H01M 8/04753; H01M 8/04992

(57) ABSTRACT

A fuel cell system includes an air flow line connected to a cathode, a cut-off valve provided in the air flow line so as to adjust an opened/closed state of the air flow line, a cooling medium configured to cool or heat a fuel cell stack, and a controller configured to adjust a position of the cut-off valve according to a driving mode of the fuel cell stack and to further adjust the position of the cut-off valve on the basis of a temperature of outside air or a temperature of the cooling medium.

### CROSS-REFERENCE TO RELATED APPLICATION(S)

This application is based on and claims priority under 35 U.S.C. 119 to Korean Patent Application No. 10-2022-0151903, filed on Nov. 14, 2022, in the Korean Intellectual Property Office, the disclosure of which is herein incorporated by reference in its entirety.

### BACKGROUND OF THE DISCLOSURE

### 1. Technical Field

The present disclosure relates to a fuel cell system and a fuel cell system control method and, more specifically, to a method for controlling an air cut-off valve (ACV) of the fuel cell system.

### 2. Description of the Prior Art

A fuel cell refers to a device for generating electric energy through an electrochemical reaction inside a fuel cell stack by using hydrogen and air supplied from the outside. A fuel cell may be used as the source of electric power in various fields (for example, a fuel cell electric vehicle (FCEV), a fuel cell for power generation).

A fuel cell system includes a fuel cell stack having multiple fuel cell cells stacked and used as a power source, a fuel supply system for supplying fuel (hydrogen and the like) to the fuel cell stack, an air supply system for supplying an oxidizer (oxygen) necessary for the electrochemical reaction, and a water/heat management system for controlling the temperature of the fuel cell stack.

The fuel supply system decompresses compressed hydrogen in a hydrogen tank and supplies the same to the anode (fuel electrode) of the fuel cell stack. The air supply system activates an air compressor so as to supply air suctioned from outside the system or the vehicle to the cathode (air electrode) of the fuel cell stack.

If hydrogen is supplied to the fuel electrode of the fuel cell stack, and if oxygen is supplied to the air electrode, hydrogen ions are separated through a catalyst reaction at the fuel electrode. The separated hydrogen ions are delivered to the cathode (air electrode) through an electrolyte membrane. At the cathode, the hydrogen ions separated at the fuel electrode, electrons, and oxygen undergo an electrochemical reaction together, thereby generating electric energy. Specifically, electrochemical oxidation of hydrogen occurs at the fuel electrode, and electrochemical reduction of oxygen occurs at the air electrode. The resulting electrons, when moved, generate electricity and heat, and a chemical action that combines hydrogen and oxygen generates water vapor or water.

A discharge device is provided to discharge byproducts (water vapor, water, heat) generated in the electric energy generating process by the fuel cell stack, as well as unreacted hydrogen and oxygen. Gases such as water vapor, hydrogen, and oxygen are discharged to the atmosphere through a discharge passage.

The electrochemical reaction occurring in the fuel cell is expressed by a reaction formula as follows:

[reaction at anode]2H₂(g)→4H⁺(aq.)+4e⁻

[reaction at cathode]O₂(g)+4H⁺(aq.)+4e⁻→2H₂O(l)

[entire reaction]2H₂(g)+O₂(g)→2H₂O(l)+electric energy+thermal energy

As described in the above reaction formula, hydrogen molecules are decomposed at the anode, thereby generating four hydrogen ions and four electrons. The electrons move through an external circuit, thereby generating an electric current (electric energy). The hydrogen ions move to the cathode through the electrolyte membrane and undergo a cathode reaction, thereby generating water and heat as byproducts of the electrochemical reaction.

Meanwhile, the air cut-off valve (ACV) is configured to adjust the flow rate of air flowing into the air flow line connected to the cathode. The ACV closes the air flow line, when the fuel cell stack is stationary (powered off), such that no air flows into the air flow line.

When the fuel cell stack is powered off, the inside of the fuel cell stack is filled with hydrogen to prevent the fuel cell stack from degrading. If the fuel cell stack is again powered on, the ACV is opened such that the hydrogen gas is discharged out of the fuel cell stack.

If the ACV is opened all at once, the concentration of hydrogen gas discharged out of the fuel cell stack may exceed environmental regulation standards. Therefore, when the fuel cell stack is initially started, the ACV is opened to a small degree such that the environmental regulation standards are not exceeded, thereby discharging the hydrogen gas.

However, the fuel cell stack has a wide range of operating temperatures (−30° to 90° Celsius). Accordingly, a seal made of rubber, which constitutes the ACV, expands or contracts to a large degree according to the coefficient of expansion of the seal. If the temperature is not considered, an error occurs in the concentration of discharged hydrogen.

In addition, if the voltage drops below a lower limit when the fuel cell stack operates, degradation is accelerated. It is therefore desirable to prevent the voltage of the fuel cell stack from dropping below the lower limit.

Accordingly, it is desirable to micro-adjust the flow rate of air to prevent the voltage of the fuel cell stack from dropping below the lower limit. Thus, it is desirable to micro-control the ACV.

Additionally, if the operating temperature of the fuel cell stack is not considered, errors occur due to expansion/contraction of the seal.

Therefore, it is desirable that the ACV is micro-controlled in view of the operating temperature of the fuel cell stack.

The above descriptions regarding background technologies have been made only to enhance understanding of the background of the present disclosure. Thus, the above descriptions are not to be deemed by those of ordinary skill in the art to correspond to already-known prior art.

### SUMMARY OF THE DISCLOSURE

The present disclosure has been proposed to solve the above-mentioned problems, and it is an aspect of the present disclosure to provide a fuel cell system and a fuel cell system control method wherein a position of an air cut-off valve (ACV) between an open position and a closed position is corrected or fine-tuned in view of the operating temperature of a fuel cell stack. Thus, when the fuel cell stack is started, hydrogen can be discharged in conformity with environmental regulations and the voltage of the fuel cell stack is prevented from dropping below the lower limit. As a result, the fuel cell stack is prevented from degrading, maintaining the performance thereof and improving the durability thereof.

In accordance with an aspect of the present disclosure, a fuel cell system may include: an air flow line connected to a cathode; a cut-off valve provided in the air flow line so as to adjust an open/closed state of the air flow line; a cooling medium configured to cool or heat a fuel cell stack; and a controller configured to adjust a position of the cut-off valve between an open position and a closed position according to a driving mode of the fuel cell stack and to further adjust the position of the cut-off valve on the basis of a temperature of outside air or a temperature of the cooling medium.

The controller may further adjust the position of the cut-off valve on the basis of the temperature of outside air or the temperature of the cooling medium during a startup of the fuel cell stack or during control of the voltage lower limit of the fuel cell stack.

During a startup of the fuel cell stack, the position of the cut-off valve may be further adjusted on the basis of the temperature of outside air. During control of the voltage lower limit of the fuel cell stack, the position of the cut-off valve may be further adjusted on the basis of the temperature of cooling medium.

The controller may configure a reference temperature range of the outside air or the cooling medium and further adjust the position of the cut-off valve when the temperature is above or below the reference temperature range.

The controller may further adjust the position of the cut-off valve such that the cut-off valve is further opened when the temperature of outside air or the temperature of the cooling medium is above the reference temperature range.

The controller may further adjust the position of the cut-off valve such that the cut-off valve is further closed when the temperature of outside air or the temperature of the cooling medium is below the reference temperature range.

The cut-off valve may include a seal configured to prevent air inflow into the cathode when the cut-off valve is closed. The controller may further adjust the position of the cut-off valve on the basis of the coefficient of thermal expansion of the seal.

The controller may determine the degree of contraction or expansion of the seal according to [Equation 1] below and may further adjust the position of the cut-off valve on the basis of the degree of contraction or expansion of the seal.

γ=1+α(t−t₀) [Equation 1]
γ: degree of contraction or expansion of seal
α: coefficient of thermal expansion of seal
t₀: reference temperature
t: temperature of outside air or cooling medium.

The controller may calculate a corrected or fine-tuned open area of the air flow line according to [Equation 2] below and accordingly may further adjust the position of the cut-off valve.

A=A₀εγ [Equation 2]
A: corrected or fine-tuned open area of air flow line
A₀: open area of air flow line at reference temperature
ε: compensation coefficient
γ: degree of contraction or expansion.

A method for controlling the fuel cell system may include: measuring the temperature of the outside air or the temperature of the cooling medium by the controller; and further adjusting the position of the cut-off valve on the basis of the measured temperature of outside air or the measured temperature of the cooling medium.

The controller may further adjust the position of the cut-off valve during a startup of the fuel cell stack or during control of the voltage lower limit of the fuel cell stack.

The controller may configure a reference temperature range of the outside air or the cooling medium and may further adjust the position of the cut-off valve when the temperature is above or below the reference temperature range.

A fuel cell system and a fuel cell system control method according to the present disclosure are advantageous in that the position of an ACV is corrected or fine-tuned in view of the operating temperature of a fuel cell stack. Thus, when the fuel cell stack is started, hydrogen can be discharged in conformity with environmental regulations and the voltage of the fuel cell stack is prevented from dropping below the lower limit. The fuel cell stack thus is prevented from degrading, maintaining the performance thereof and improving the durability thereof.

### BRIEF DESCRIPTION OF THE DRAWINGS

The above and other aspects, features, and advantages of the present disclosure should be more apparent from the following detailed description taken in conjunction with the accompanying drawings, in which:

FIG. 1 is a schematic view of a fuel cell system according to an embodiment of the present disclosure;

FIG. 2 is an exploded view of a cut-off valve of the fuel cell system;

FIG. 3 illustrates the state of a seal according to the temperature; and

FIG. 4 is a flowchart of a method for controlling a fuel cell system according to an embodiment of the present disclosure.

### DETAILED DESCRIPTION OF EMBODIMENTS

Hereinafter, embodiments disclosed in the present specification are described in detail with reference to the accompanying drawings. The same or similar elements are given the same and similar reference numerals throughout the drawings and duplicate descriptions thereof have been omitted.

In describing the embodiments disclosed in the present specification, where a detailed description of a relevant known technology was determined to unnecessarily obscure the gist of the present disclosure, a detailed description thereof has been omitted. Furthermore, the accompanying drawings are provided only to enhance understanding of the embodiments disclosed in the present specification. The technical spirit disclosed herein is not limited to the accompanying drawings. Thus, it should be understood that all changes, equivalents, or substitutes thereof are included in the spirit and scope of the present disclosure.

Terms including an ordinal number such as “first”, “second”, or the like may be used to describe various elements, but the elements are not limited by the terms. The above terms are used only for the purpose of distinguishing one element from another element.

A singular expression may include a plural expression unless they are definitely different in a context.

As used herein, the expression “include” or “have” and variations thereof are intended to specify the existence of mentioned features, numbers, steps, operations, elements, components, or combinations thereof. These expressions should be construed as not precluding the possible existence or addition of one or more other features, numbers, steps, operations, elements, components, or combinations thereof. When a component, device, element, or the like of the present disclosure is described as having a purpose or performing an operation, function, or the like the component, device, or element should be considered herein as being “configured to” meet that purpose or perform that operation or function.

In accordance with an aspect of the present disclosure, a fuel cell system includes: an air flow line 300 connected to a cathode; a cut-off valve 400 provided in the air flow line 300 so as to adjust an open/closed state of the air flow line; a cooling medium configured to cool or heat a fuel cell stack 100; and a controller 500. The controller 500 is configured to adjust a position of the cut-off valve 400 between an open position and a closed position according to the driving mode of the fuel cell stack 100 and to further adjust the position of the cut-off valve 400 on the basis of the temperature of outside air or the temperature of the cooling medium. As used herein, or outside air refers to air that is outside of the vehicle or the fuel cell system.

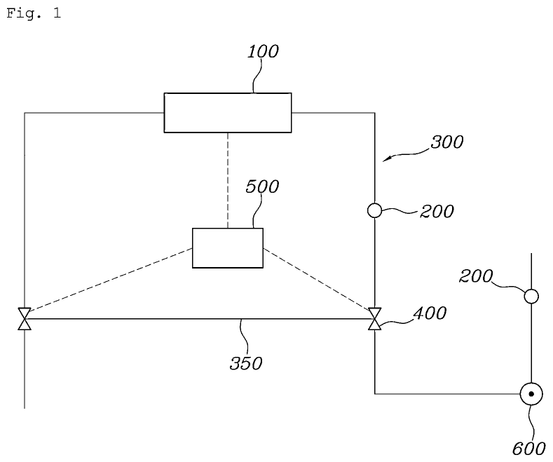

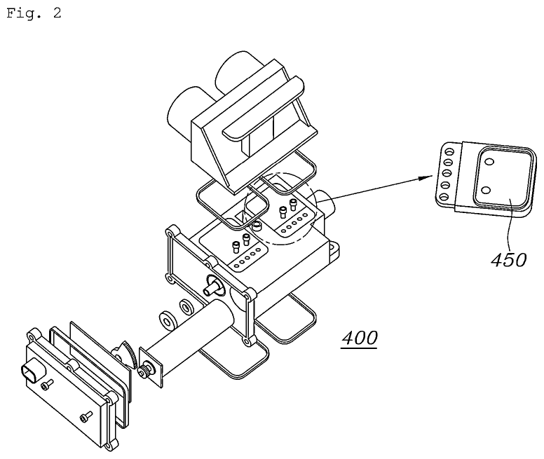

Specifically, FIG. 1 is a schematic view of a fuel cell system according to an embodiment of the present disclosure. FIG. 2 is an exploded view of a cut-off valve of the fuel cell system according to an embodiment of the present disclosure.

Referring to FIG. 1, the air flow line 300 is connected to the cathode such that air pressurized by an air compressor 600 flows therethrough. The air flow line 300 is opened/closed by the cut-off valve 400. When the fuel cell is powered on, the cut-off valve 400 opens the air flow line 300. When the fuel cell is powered off, the cut-off valve 400 closes the air flow line 300.

When the air flow line 300 is opened, air pressurized by the air compressor 600 flows into the cathode of the fuel cell stack 100 and reacts with hydrogen, thereby generating electric power.

When the fuel cell stack 100 is powered off, the air flow line 300 is closed to prevent outside air from flowing into the cathode and reacting inside the fuel cell stack 100.

After the air flow line 300 is closed, the inside of the fuel cell stack 100 is filled with high-concentration hydrogen to prevent the fuel cell stack 100 from degrading.

The opening/closing, i.e., the position of the cut-off valve 400 between an open position (e.g., fully opened) and a closed position (e.g., fully closed) is adjusted by a driving motor configured to open/close the cut-off valve 400. Referring to FIG. 2, the cut-off valve 400 is provided with a sealing means, i.e., a seal 450 for preventing air from flowing into the cathode when the cut-off valve 400 is closed.

Specifically, the seal 450 induces air to a bypass line 350 when the cut-off valve 400 is closed and maintains tight contact with peripheral components (for example, a valve housing) such that no air flows into the air flow line 300. Therefore, the seal 450 may be made of a rubber material having flexibility such as Ethylene Propylene Diene Monomer (EPDM).

The seal 450 may expand or contract according to its temperature, which may be changed by driving or operating the fuel cell stack 100. Thus, the cut-off valve 400 needs to be further adjusted in view of the temperature of the fuel cell stack 100 when the cut-off valve 400 is micro-adjusted.

The controller 500 adjusts opening/closing or a position of the cut-off valve 400 according to the driving mode of the fuel cell stack 100. When the fuel cell stack 100 operates at a high output, the cut-off valve 400 may be controlled to be opened. When the fuel cell stack 100 needs no operation, the cut-off valve 400 may be controlled to be closed.

Particularly, the cut-off valve 400 needs to be micro-controlled to be opened during a startup of the fuel cell stack 100 or during control of the voltage lower limit of the fuel cell stack 100.

Specifically, during a startup of the fuel cell stack 100, the cut-off valve 400 needs to be micro-controlled to be opened such that hydrogen that fills the cathode is discharged in accordance with environmental standards.

In addition, during control of the voltage lower limit of the fuel cell stack 100, the cut-off valve 400 needs to be micro-controlled such that the voltage does not drop below the lower limit.

The controller 500 performs opening/closing adjustment (e.g., adjusts a position) of the cut-off valve 400. However, the fuel cell stack 100 typically operates in an environment having a temperature of −30°-90° Celsius. Therefore, thermal expansion or contraction of the seal 450 that constitutes the cut-off valve 400 may generate a micro error in connection with control of the cut-off valve 400 when the fuel cell stack 100 operates.

Therefore, the controller 500 may further adjust the amount of opening/closing, i.e., the position of the cut-off valve 400 on the basis of the temperature of outside air or the temperature of the cooling medium, thereby reducing or eliminating the micro error that may occur in connection with control of the cut-off valve 400.

The controller may include a communication device configured to communicate with another controller or a sensor in order to control entrusted functions. The controller may also include a memory configured to store an operating system, logic commands, input/output information, and the like. The controller may further include one or more processors configured to perform determination, operation, decision, and the like necessary to control entrusted functions.

The fuel cell system may further include a temperature sensor 200 configured to measure the temperature of outside air or the cooling medium. The temperature sensor 200 may be provided at the front end of the air compressor 600 or may be provided in the air flow line 300 near the entrance of the fuel cell stack 100.

The temperature sensor for measuring the temperature of the cooling medium may be provided in a cooling line through which a cooling medium for cooling the fuel cell stack flows.

The controller 500 may further adjust the position of the cut-off valve 400 on the basis of the temperature or outside air or the temperature of the cooling medium during a startup of the fuel cell stack 100 or during control of the voltage lower limit of the fuel cell stack 100.

Specifically, during a startup of the fuel cell stack 100, the cut-off valve 400 needs to be micro-adjusted such that hydrogen remaining in the cathode is discharged. Therefore, it is necessary to identify the current temperature of the fuel cell stack 100 and then to further adjust the position of the cut-off valve 400.

In addition, during control of the voltage lower limit of the fuel cell stack 100, the cut-off valve 400 needs to be micro-adjusted such that the voltage does not drop below the lower limit. Therefore, it is necessary to identify the current temperature of the fuel cell stack 100 and then to further adjust the position of the cut-off valve 400.

The controller 500 may further adjust the position of the cut-off valve 400 on the basis of the temperature of outside air during a startup of the fuel cell stack 100. The controller 500 may further adjust the position of the cut-off valve 400 on the basis of the temperature of the cooling medium during control of the voltage lower limit of the fuel cell stack 100.

Specifically, during a startup of the fuel cell stack 100, the external environment has a large influence, and the temperature of outside air may thus be considered as the temperature of the fuel cell stack 100.

During control of the voltage lower limit of the fuel cell stack 100, which is currently operating, the external influence, such as the temperature of outside air is negligible, and the temperature inside of the fuel cell system is considered as having a larger influence.

In this case, the temperature of the cooling medium may thus be considered as the temperature of the fuel cell stack 100.

However, even during a startup of the fuel cell stack 100, the temperature of the cooling medium may be closer to the temperature of the fuel cell stack 100 than the temperature of outside air if the difference between the power-off time and the power-on time is below a threshold. Therefore, even during a startup of the fuel cell stack 100, the position of the cut-off valve 400 may be further adjusted on the basis of the temperature of the cooling medium if the difference between the power-off time and the power-on time is below a threshold.

The controller 500 may configure a reference temperature range of outside air or a reference temperature range of the cooling medium. If the temperature is above or below the reference temperature range, the controller 500 may further adjust the position of the cut-off valve 400.

Specifically, the reference temperature range may be 15°-30° Celsius. In other words, in a range close to room temperature, the coefficient of thermal expansion has an insignificant influence and the influence of temperature is thus negligible.

Therefore, the position of the cut-off valve 400 may not be further adjusted if the temperature of outside air or the cooling medium is within the reference temperature range. The position of the cut-off valve 400 may be further adjusted only if the temperature is above or below the reference temperature range.

In other words, the controller 500 may further adjust the position of the cut-off valve 400 such that the cut-off valve 400 is further opened when the temperature of outside air or the cooling medium exceeds the reference temperature range.

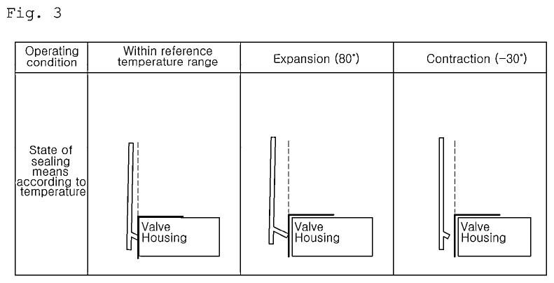

Specifically, when the temperature of outside air or the cooling medium is above the reference temperature range, the seal 450 provided on the cut-off valve 400 is expanded as illustrated in FIG. 3, thereby interfering with the flow of air. Micro adjustment of the cut-off valve 400 is thus necessary in such a direction that the cut-off valve 400 is further opened.

On the other hand, when the temperature of outside air or the cooling medium is below the reference temperature range, the controller 500 may further adjust the position of the cut-off valve 400 in such a direction that the cut-off valve 400 is further closed.

Specifically, when the temperature of the cooling medium is below the reference temperature range, the seal 450 provided on the cut-off valve 400 is contracted as illustrated in FIG. 3, thereby facilitating the flow of air. Micro adjustment of the cut-off valve 400 is thus necessary in such a direction that the cut-off valve 400 is further closed.

The controller 500 may further adjust the position of the cut-off valve 400 on the basis of the coefficient of thermal expansion of the seal 450.

Specifically, the controller 500 may determine the degree of contraction or expansion of the seal 450 by using [Equation 1] below and may further adjust the position of the cut-off valve 400 on the basis of the degree of contraction or expansion of the seal 450.

γ=1+α(t−t₀) [Equation 1]
γ: degree of contraction or expansion of seal
α: coefficient of thermal expansion of seal
t₀: reference temperature
t: temperature of outside air or cooling medium

In [Equation 1], the degree of contraction or expansion of the seal 450 refers to the amount of change in the volume of the seal with reference to the reference temperature to. In other words, when the operating temperature of the fuel cell stack 100 is equal to/higher than the reference temperature, γ has a value equal to or larger than 1, and when the operating temperature is below the reference temperature, γ has a value less than 1.

The reference temperature to is within the reference temperature range, may be room temperature, and may be selected from a range of 25°-30° Celsius.

The controller 500 may calculate the corrected or fine-tuned open area of the air flow line 300 according to [Equation 2] below and may accordingly further adjust the position of the cut-off valve 400.

A=A₀εγ [Equation 2]
A: further adjusted open area of air flow line
A₀: open area of air flow line at reference temperature
ε: compensation coefficient
γ: degree of contraction or expansion

Specifically, when the temperature of outside air or the cooling medium is above the reference temperature range, micro adjustment is thus necessary in such a direction that the cut-off valve 400 is further opened. The corrected or fine-tuned open area A of the air flow line 300 thus has a larger value than the open area A₀ of the air flow line 300 at the reference temperature, and the position of the cut-off valve 400 is further adjusted so as to have the corrected or fine-tuned open area A of the air flow line 300.

On the other hand, when the temperature of outside air or the cooling medium is below the reference temperature range, micro adjustment is thus necessary in such a direction that the cut-off valve 400 is further closed. The corrected or fine-tuned open area A of the air flow line 300 thus has a smaller value than the open area A₀ of the air flow line 300 at the reference temperature, and the position of the cut-off valve 400 is further adjusted so as to have the corrected or fine-tuned open area A of the air flow line 300.

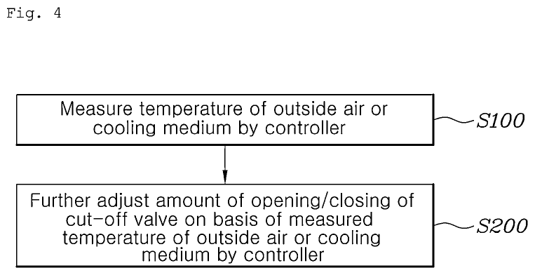

FIG. 4 is a flowchart of a method for controlling a fuel cell system according to an embodiment of the present disclosure.

Referring to FIG. 4, the method for controlling a fuel cell system includes a step (S100) and a step (200). In step (100) the controller 500 measures the temperature of outside air or the cooling medium. In step (S200) the amount of opening/closing or the position of the cut-off valve 400 is further adjusted on the basis of the measured temperature of outside air or the cooling medium.

Specifically, the controller 500 may further adjust the position of the cut-off valve during a startup of the fuel cell stack 100 or during control of the voltage lower limit of the fuel cell stack 100.

In addition, the controller 500 may configure a reference temperature range of the outside air or cooling medium. If the temperature is above or below the reference temperature range, the controller 500 may further adjust the position of the cut-off valve 400.

In other words, if the temperature of outside air or the cooling medium is above the reference temperature range, the controller 500 may further adjust the position of the cut-off valve such that the cut-off valve 400 is further opened. If the temperature of outside air or the cooling medium is below the reference temperature range, the controller 500 may further adjust the position of the cut-off valve such that the cut-off valve 400 is further closed.

Although the present disclosure has been described and illustrated in conjunction with particular embodiments thereof, it should be apparent to those of ordinary skill in the art that various improvements and modifications may be made to the present disclosure without departing from the technical idea of the present disclosure defined by the appended claims.

### BRIEF DESCRIPTION OF REFERENCE NUMERALS

100: fuel sell stack
200: temperature sensor
300: air flow line
350: bypass line
400: cut-off valve
500: controller
600: air compressor

What is claimed is:

1. A fuel cell system comprising:
an air flow line connected to a cathode;
a cut-off valve provided in the air flow line configured to adjust an opened/closed state of the air flow line;
a cooling medium configured to cool or heat a fuel cell stack; and
a controller configured to adjust a position of the cut-off valve between the opened position and the closed position according to a driving mode of the fuel cell stack and to further adjust the position of the cut-off valve on the basis of a temperature of outside air or a temperature of the cooling medium.

2. The fuel cell system of claim 1, wherein the controller further adjusts the position of the cut-off valve on the basis of the temperature of the outside air or the temperature of the cooling medium during a startup of the fuel cell stack or during control of a voltage lower limit of the fuel cell stack.

3. The fuel cell system of claim 1, wherein, during a startup of the fuel cell stack, the position of the cut-off valve is further adjusted on the basis of the temperature of the outside air, and wherein, during control of a voltage lower limit of the fuel cell stack, the position of the cut-off valve is further adjusted on the basis of the temperature of the cooling medium.

4. The fuel cell system of claim 1, wherein the controller configures a reference temperature range of the outside air or of the cooling medium and further adjusts the position of the cut-off valve when the temperature is above or below the reference temperature range.

5. The fuel cell system of claim 4, wherein the controller further adjusts the position of the cut-off valve such that the cut-off valve is further opened when the temperature of the outside air or the temperature of the cooling medium is above the reference temperature range.

6. The fuel cell system of claim 4, wherein the controller further adjusts the position of the cut-off valve such that the cut-off valve is further closed when the temperature of the outside air or the temperature of the cooling medium is below the reference temperature range.

7. The fuel cell system of claim 4, wherein the cut-off valve comprises a seal configured to prevent air inflow into the cathode when the cut-off valve is closed, and wherein the controller further adjusts the position of the cut-off valve on the basis of a coefficient of thermal expansion of the seal.

8. The fuel cell system of claim 7, wherein the controller determines the degree of contraction or expansion of the seal according to a first formula, and further adjusts the position of the cut-off valve on the basis of the degree of contraction or expansion of the seal,
wherein the first formula is
γ=1+α(t−t₀)
and wherein
γ: degree of contraction or expansion of the seal
α: coefficient of thermal expansion of the seal
t₀: reference temperature
t: the temperature of the outside air or the cooling medium.

9. The fuel cell system of claim 8, wherein the controller calculates a corrected open area of the air flow line according to a second formula and accordingly further adjusts the position of the cut-off valve,
wherein the second formula is
A=A₀εγ
and wherein
A: corrected open area of air flow line
A₀: open area of air flow line at reference temperature
ε: compensation coefficient
γ: degree of contraction or expansion.

10. A method for controlling the fuel cell system of claim 1, the method comprising:
measuring the temperature of the outside air or the temperature of the cooling medium by the controller; and
further adjusting the position of the cut-off valve on the basis of the measured temperature of outside air or the measured temperature of the cooling medium.

11. The method of claim 10, wherein the controller further adjusts the position of the cut-off valve during a startup of the fuel cell stack or during control of a voltage lower limit of the fuel cell stack.

12. The method of claim 10, wherein the controller configures a reference temperature range of the outside air or the cooling medium and further adjusts the position of the cut-off valve when the temperature is above or below the reference temperature range.
